(19) United States
(12) Patent Application Publication
(10) Pub. No.: US 2014/0147718 A1
(43) Pub. Date: May 29, 2014

(54) HAND-HELD POWER TOOLS AND BATTERY PACKS THEREFOR

(71) Applicants: Nobuyasu Furui, Anjo-Shi (JP); Hitoshi Suzuki, Anjo-Shi (JP); Masaaki Fukumoto, Anjo-Shi (JP); Takuya Umemura, Anjo-Shi (JP); Kosuke Ito, Anjo-Shi (JP)

(72) Inventors: Nobuyasu Furui, Anjo-Shi (JP); Hitoshi Suzuki, Anjo-Shi (JP); Masaaki Fukumoto, Anjo-Shi (JP); Takuya Umemura, Anjo-Shi (JP); Kosuke Ito, Anjo-Shi (JP)

(73) Assignee: MAKITA CORPORATION, ANJO-SHI (JP)

(21) Appl. No.: 14/233,837

(22) PCT Filed: Jul. 12, 2012
(86) PCT No.: PCT/JP2012/004505

§ 371 Date: Jan. 20, 2014

Related U.S. Application Data
(60) Provisional application No. 61/511,088, filed on Jul. 24, 2011.

(51) Int. Cl. B25F 5/00

(52) U.S. Cl. CPC B25F 5/00
USPC 429/99

(57) ABSTRACT

A battery pack adapted to be attached to, and drive, a hand-held power tool includes a plurality of series-connected battery cells having a nominal power output of at least 300 Watts. The battery pack weighs less than 275 grams and has a nominal power output to weight ratio of at least at least 1100 Watts/kilogram. A power tool system or kit includes such a battery pack and a hand-held, battery-powered tool adapted to operate with a battery pack having a nominal power output of 600 Watts or more.

### CROSS-REFERENCE

This application claims priority to U.S. provisional patent application No. 61/511,088 filed on Jul. 24, 2011, the contents of which are fully incorporated herein by reference.

### TECHNICAL FIELD

The present invention generally relates to the field of hand-held power tools and battery packs utilized to drive such power tools.

### BACKGROUND

U.S. Pat. No. 7,273,159 discloses a cordless power tool system configured to output a maximum power (maximum watts out—“MWO”) of at least 475 Watts while having a maximum power output to weight ratio of at least 70 Watts per pound (W/lb), i.e. about 154 Watts/kilogram.

Makita Corporation of Anjo, Japan, the assignee/applicant of the present application, has previously sold an 18V battery pack for hand-held power tools having a nominal power output of at least 300 Watts and a weight of about 380 grams. Thus, such a known battery pack itself has a nominal power output to weight ratio of at least about 790 Watts/kilogram.

US 2003/0203669 A1 discloses a battery pack system for hand-held power tools that includes a plurality of different-sized battery packs, each having the same geometry for the engaging and contact elements. The different-sized battery packs output the same nominal or rated current, but are designed to store different amounts of power/energy.

### SUMMARY

In the hand-held power tool field, many users require at least two sets of power tools and battery packs to be able to optimally perform a range of power tool operations requiring different energy outputs.

For example, certain hand-held power tool applications require a relatively large amount of power/energy to perform the power tool operation. In this situation, a first set of power tool and battery pack will be utilized. The battery pack of the first set is usually capable of outputting a relatively high amount of power (MWO), such as at least 600 Watts, and the power tool of the first set, in particular the electric motor and/or control electronics, is designed to safely utilize such a large power source to perform a heavy-duty (high output power) operation without damage to the power tool or battery pack. Since this first set of power tool and battery pack is relatively heavy, it may quickly cause user fatigue if the power tool operation requires holding the power tool system in a strenuous position.

On the other hand, if the user expects to perform a relatively light (low output power) power tool operation for an extended period of time, the user typically prefers to use a second set of hand-held power tool and battery pack, wherein the second set is much lighter overall. Many light, low power operations can be performed in a satisfactory manner using a battery pack that is capable of outputting about 300 Watts or more. As a result of the lower output power requirements, lighter power tool/battery pack systems are possible that are less burdensome and tiring to use for a long period of time.

As noted above in the Background section, a 300 Watt battery pack weighing 380 grams is known for use in the second situation (low output power), but further improvements, including e.g. ergonomic improvements, would be desirable.

It is an object of the present teachings to provide improved battery packs and/or hand-held power tool systems, which may preferably overcome one or more of the above-noted problems of the prior art.

Therefore, in one aspect of the present teachings, battery packs are taught that have a nominal power of at least 300 Watts and that weigh less than 275 grams, more preferably equal to or less than 250 grams. Such battery packs preferably have a nominal power output to weight ratio of at least 1100 Watts/kilogram, more preferably at least 1200 Watts/kilogram.

Battery packs according to this aspect of the present teachings are capable of providing sufficient output power for most light power tool operations, while significantly decreasing weight and thus advantageously reducing user fatigue.

Preferably, the battery packs also have a nominal or rated output voltage of at least 20 volts, preferably about 21-30 volts, even more preferably between 25-26 volts, and may comprise a plurality of lithium-based battery cells, e.g., equal to or less than 8. Lithium-ion battery cells are presently preferred.

In addition or in the alternative, the battery packs may have a nominal power output of at least 300 Watts and may have a nominal power output to weight ratio of at least 1100 Watts/kilogram. In addition or in the alternative, the battery packs may have a nominal power output of at least 350 Watts and may have a nominal power output to weight ratio of at least 1170 Watts/kilogram. In addition or in the alternative, the battery packs may have a nominal power output of at least 370 Watts and may have a nominal power output to weight ratio of at least 1230 Watts/kilogram.

In addition or in the alternative, the battery packs may have a nominal power output of at least 300 Watts and weigh less than 250 grams. Such battery packs have a nominal power output to weight ratio of at least 1200 Watts/kilogram.

In addition or in the alternative, the battery packs may have a nominal power output of at least 330 Watts and may have a nominal power output to weight ratio of at least 1320 Watts/kilogram. In addition or in the alternative, the battery packs may have a nominal power output of at least 350 Watts and may have a nominal power output to weight ratio of at least 1400 Watts/kilogram. In addition or in the alternative, the battery packs may have a nominal power output of at least 370 Watts and may have a nominal power output to weight ratio of at least 1500 Watts/kilogram.

In addition or in the alternative, the battery packs may weigh less than 235 grams and have a nominal power output to weight ratio of at least 1275 Watts/kilogram. In addition or in the alternative, the battery packs may weigh less than 220 grams and have a nominal power output to weight ratio of at least 1360 Watts/kilogram.

In addition or in the alternative, the battery packs may comprise six, seven or eight series-connected lithium-based (Li-based) battery cells, such as Li-ion battery cells, each having a nominal voltage of 3.6-3.7 V and a weight of about 20 grams or less. Such a selection of battery cells provides a set of output voltage/weight of 21.6V/120 g, 25.2V/140 g and 28.8V/160 g, respectively. The weight of each cell may preferably be about 18 grams or less or 17 grams, thereby increasing the voltage to weight ratio. Generally speaking, the remaining components of the battery pack (e.g., outer plastic shell, connectors, control electronics, packing, leads, etc.) may amount to about 100-200 g, e.g., 150-190 g, but preferably may be further reduced to 100-150 g, e.g., 100-120 g, thereby making possible battery packs according to one aspect of the present teachings. Such battery cells preferably also have relatively compact overall dimensions, namely a diameter of about 14 mm or less and a length of about 50 mm or less. Thus, in addition to providing a light-weight battery pack, the present teachings also make possible compact battery packs.

Hand-held power tool systems or kits are also described herein that include a battery pack according to the above- or below-described teachings and a hand-held, battery-powered tool configured to safely operate when connected to a battery pack having a nominal power output of at least 600 Watts, e.g. more than 700 Watts or even more than 800 Watts.

The hand-held power tool system or kit may also preferably include a second battery pack capable of outputting at least 600 Watts, e.g. more than 700 Watts or even more than 800 Watts. In this aspect of the present teachings, the user is provided with a single power tool that can be operated at lower power using the first light-weight battery, while advantageously minimizing fatigue, and that can also be operated at higher power using the second higher-power battery pack, thereby advantageously enabling a wide range of power tool operations using a single power tool.

All power (Watt) values expressed in the present disclosure are intended to encompass the nominal or rated power output value, even if only transitory. In certain embodiments of the present teachings, maximum sustained outputs of the battery packs may be less than the indicated nominal or rated values.

For example, nominal or rated output power values (Wnom), as used in the present teachings, may be calculated according to the following equation:

Wnom={(Vmid−Vmin)/Rbatt}*Vmin

where:

Wnom [W] is the nominal output power,

Vmid [V] is the battery open circuit voltage (OCV) at a state of charge (SOC) of 50% (Vmid is typically about 3.7V/cell for a Li-ion battery),

Vmin [V] is the lowest or minimum permissible voltage of the battery cell during normal operation (Vmin is typically about 3.0V/cell for a Li-ion battery), and

Rbatt [ohm] is the impedance of the battery cell at a battery temperature of 25 degrees C.

Generally speaking, the voltage of the battery cell drops or decreases rapidly when the remaining battery capacity (i.e. battery discharge state) approaches zero.

The value for Rbatt may be measured according to the following protocol:

(1) Discharge the battery cell at 5 A for 1.0 sec,

(2) Measure the battery voltage at 1.0 sec (=V0) with the discharge current at 5 A,

(3) Gradually increase the discharge current up to 15 A over 5.0 sec,

(4) Measure the battery voltage at 5.0 sec (=V1) with the discharge current at 15 A, and

(5) Calculate Rbatt according to the equation: deltaV/deltaI=(V0−V1)/10 Amp.

Further objects, advantages, embodiments and details of the invention will be readily understood by the skilled person upon reading the following detailed description and claims in view of the appended drawings.

### BRIEF DESCRIPTION OF DRAWINGS

FIGS. 1A and 1B show a cordless, hand-held impact driver with a light-weight battery pack in an attached and detached state, respectively.

FIG. 2A shows the light-weight battery pack of FIGS. 1A and 1B in an enlarged view.

FIG. 2B shows the battery pack of FIG. 2A in an exploded view.

FIGS. 3A and 3B show the impact driver of FIGS. 1A and 1B with a higher-power battery pack in an attached and detached state, respectively.

FIG. 4A shows the higher-power battery pack of FIGS. 3A and 3B in an enlarged view.

FIG. 4B shows the higher-power battery pack of FIG. 4A in an exploded view.

FIGS. 5A and 5B show a cordless, hand-held circular saw with a light-weight battery pack in an attached and detached state, respectively.

FIGS. 6A and 6B show a cordless, hand-held driver drill with a light-weight battery pack in an attached and detached state, respectively.

FIGS. 7A and 7B show the driver drill of FIGS. 6A and 6B with a higher-power battery pack in an attached and detached state, respectively.

### DETAILED DESCRIPTION OF THE INVENTION

Representative, non-limiting examples of the present invention will be described below in greater detail. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings to provide improved battery packs, power tools, power tool systems and methods for manufacturing and using the same.

Moreover, combinations of features and steps disclosed in the following detailed description may not be necessary to practice the invention in the broadest sense, and are instead taught merely to particularly describe representative examples of the invention. Furthermore, various features of the below-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the particular combination of features in the embodiments and/or the claims. In addition, all value ranges or indications of groups of entities are intended to disclose every possible intermediate value or intermediate entity for the purpose of original written disclosure, as well as for the purpose of restricting the claimed subject matter.

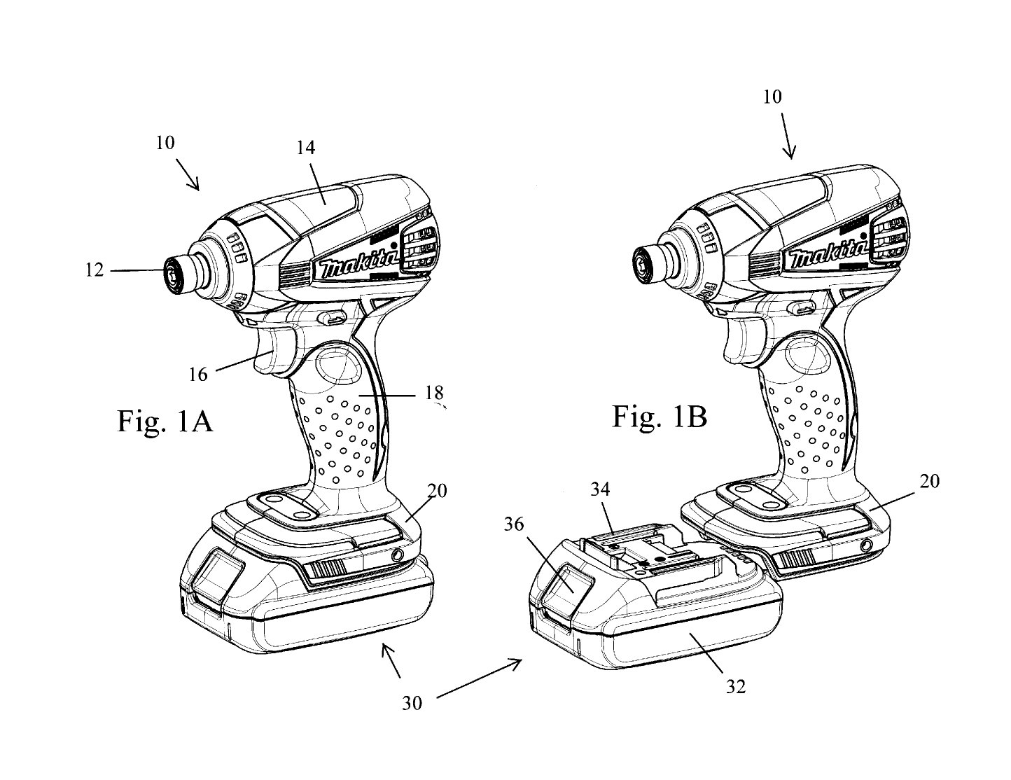

FIGS. 1A and 1B illustrate a representative hand-held, cordless impact driver 10 together with a light-weight battery pack 30 according to the present teachings. The impact driver 10 generally comprises a tool chuck 12 configured or adapted to retain a rotatable tool, such as a screw bit (not shown), a gear transmission and motor housing 14, a trigger or switch 16 for manually activating an electric motor (not shown) disposed within the housing 14, a hand grip 18 and a battery holder 20. The electronic motor may drive the rotatable tool via a reduction gear transmission (not shown).

Referring to FIG. 1B, the battery pack 30 generally comprises an outer protective shell or casing 32, slide rails 34 configured to slidably engage with corresponding rails (not shown) disposed in or on the battery holder 20 and a latch 36 for locking and unlocking the battery pack 30 to the battery holder 20. The present teachings are not limited to any particular geometry or arrangement for the physical (detachable) engagement structures and electronic contact structures of the battery pack 30 and/or the battery holder 20.

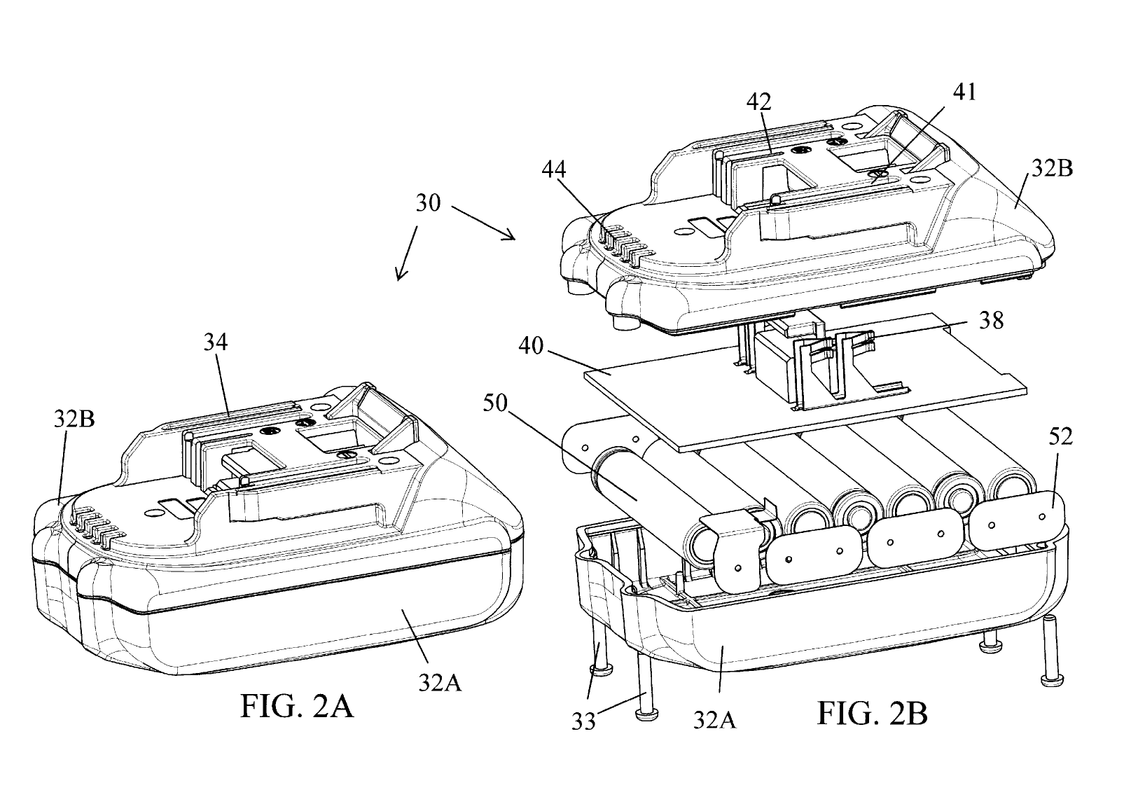

Referring now to FIGS. 2A and 2B, the battery pack 30 will be described in greater detail. The outer casing 32 may generally comprise a lower shell 32A joined to an upper shell 32B by screws 33. The upper shell 32B includes various structures for engaging the battery holder 20 or a battery charger (not shown) and/or for operation of the battery pack 30, as is well known in the art.

Battery terminals 38 (only one is numbered) may be mounted on a circuit board 40, which may optionally also act as a separator plate. While various electrical components may be mounted on the circuit board 40 as is well known in the art, illustration of such electrical components has been omitted for simplicity.

The battery terminals 38 are disposed within grooves 41 defined in the slide rails 34 in order to contact corresponding battery terminals (not shown) disposed in the battery holder 20. A groove 42 for a controller port may be provided to permit communications between a first controller or CPU (not shown), including at least one microprocessor and memory/storage, disposed in the tool 10 and a second controller or CPU (not shown), including at least one microprocessor and memory/storage, disposed in the battery pack 30. Air vents 44 permit air to be communicated into the battery pack 30 for cooling the interior of the battery pack 30 during charging and/or during discharging (e.g., operation of the power tool 10).

The battery pack 30 further includes a plurality of battery cells 50 that are connected in series via a plurality of conductors (metal leads) 52. Preferably, six, seven or eight lithium ion battery cells (nominal voltage: 3.6-3.7 V each) are connected in series, which would provide battery packs 30 having nominal output voltages of about 21.6-22.2 V, 25.2-25.9 V and 28.8-29.6 V, respectively.

The nominal voltage of a lithium metal oxide cell may generally vary within a range of about 3.6-3.7V. In the present description, the value of 3.6V has generally been used for simplicity, but it should be understood that, in practice, small variations from 3.6V are possible, which may affect some of the calculations herein. Actual values for the calculations should be based upon the actual voltage of the battery cells, regardless of whether lithium-based battery cells are utilized or another battery chemistry is utilized.

In order to achieve a suitable power/weight ratio, it is preferred to use relatively narrow battery cells 50. Such battery cells 50 preferably have a diameter of about 14 mm or less, a length of about 50 mm or less and a unit weight of about 20 g or less. For simplicity purposes, such battery cells may be referred to as a “14500 type” battery cell.

For example, if seven such battery cells are connected in series, the battery pack 30 will have a nominal maximum current output of about 15 amps, a nominal output voltage of about 25.2-25.9 V, a nominal power output greater than 300 Watts (in fact up to about 375 Watts), a capacity of about 0.6 amp-hour and a weight less than 300 grams, more preferably less than 280 grams, even more preferably less than 250 grams.

Such relatively narrow battery cells 50 provide an additional advantage, namely a high surface area to volume ratio. This enables increased heat dissipation during charging and discharge (use of the tool 10) as compared to battery cells typically utilized in power tool battery packs (such as 18650 type battery cells), thereby maintaining the battery cells 50 at lower temperatures, which means less or no time is required for battery cooling operations and/or increased battery service life due to the avoidance of excess battery temperatures. Generally speaking, such battery cells 50 never reach elevated temperatures during use that would require cooling prior to recharging. Therefore, recharging operations can be frequently and quickly performed without having to wait for the battery pack to cool.

In particular, a battery cell having a diameter (phi) of 14 mm and a length of 50 mm would have a surface area (2506 mm²) to volume (7693 mm³) ratio of about 0.33. Generally speaking, it is presently preferred that the battery cells utilized with the present teachings have a ratio of surface area to volume that is at least 0.30.

In another aspect of the present teachings, the battery cells 50 preferably have an internal resistance (Rbatt) equal to or less than 50 milli-ohms, more preferably equal to or less than 45 milli-ohms, even more preferably equal to or less than 40 milli-ohms.

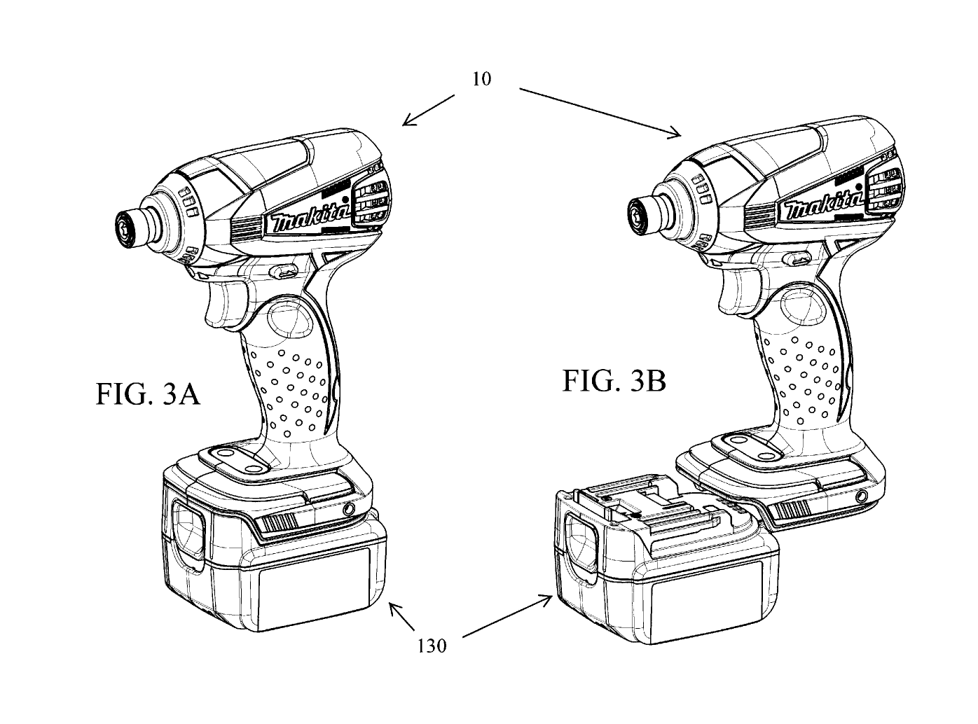

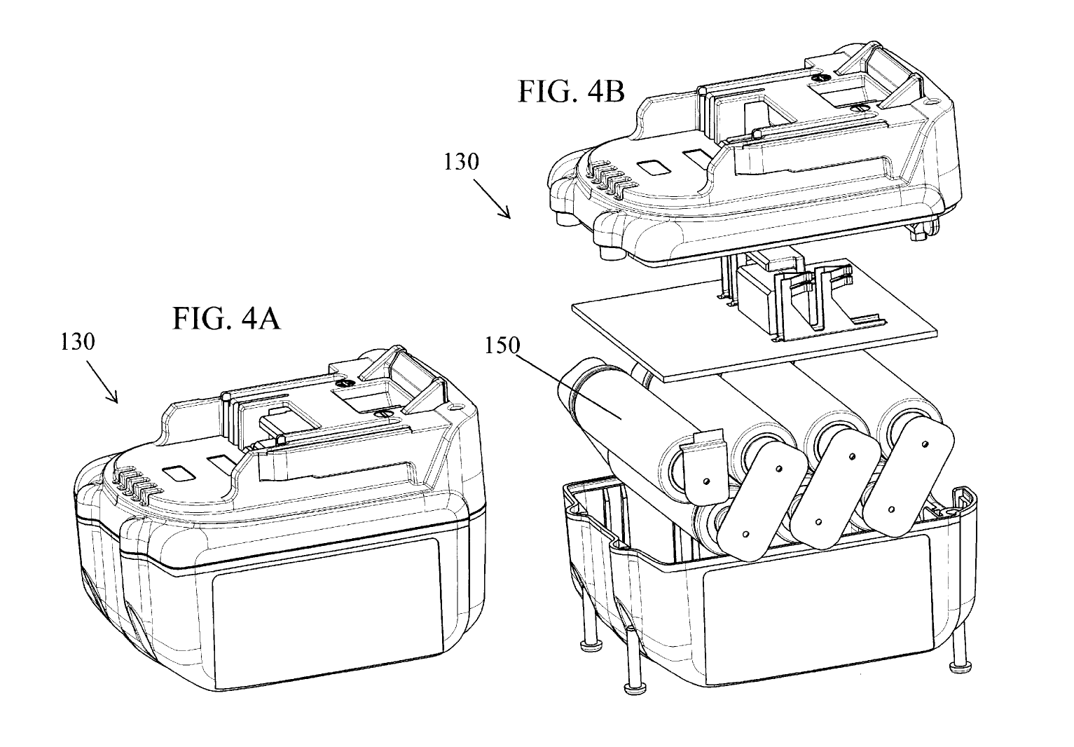

FIGS. 3 and 4 will now be utilized to describe another aspect of the present teachings. The same impact driver 10 is utilized in the power tool system shown in FIGS. 3A and 3B and therefore, it does not require further explanation.

However, a larger, higher-power battery pack 130 has been attached to the impact driver 10 in FIG. 3A and is configured to output a higher nominal power, preferably at least 600 Watts. Since all components of the larger battery pack 130 generally correspond to the corresponding components of the battery pack 30 shown in FIG. 2B, it is not necessary to further describe the same components. Instead, the description concerning the same or corresponding components is incorporated into the description of the present embodiment.

As compared to the light-weight battery pack 30 shown in FIGS. 1 and 2, the higher-power battery pack 130 differs in one important aspect, namely larger battery cells 150 are utilized as shown in FIG. 4B. In this embodiment, six to eight, preferably seven, battery cells 150 are connected in series to provide a nominal maximum (peak) output current greater than or equal to 30 amps at a nominal output voltage of about 25.2-25.9 V. Battery cell type 18650 available, for example from Sanyo Electric Co., Ltd., Electronic Components, of Osaka Japan or various other battery manufacturers, may be advantageously utilized in this higher-power battery pack 130 and such battery cells 150 have a diameter of 18 mm and a length of 65 mm.

For comparison purposes, the 18650 type battery cells have a surface area (4183 mm²) to volume (16532 mm³) ratio of about 0.25. Such battery cells may require cooling after use and prior to charging to avoid damaging the battery cells during the charging operation.

Thus, in a further aspect of the present teachings, a kit or power tool system is provided that includes a power tool 10, a first light-weight battery pack 30 and a second high-power battery pack 130. It is preferred that the number of series-connected cells in the first light-weight battery pack 30 and the number of series-connected cells in the second high-power battery pack 130 are the same and the nominal voltage of the first light-weight battery pack 30 and the nominal voltage of the second high-power battery pack 130 are the same. This kit or system provides the advantage that the user is not required to purchase two different-sized or differently-designed power tools for performing a range of power tool operations of the same basic type. Rather, when relatively lower power operations will be performed, the user can attach the light-weight battery pack 30 to the power tool 10 and perform the power tool operations while minimizing user fatigue. However, if a high-power (heavy-duty) power tool operation is necessary, the user can replace the light-weight battery pack 30 with the higher power battery pack 130 according to the present teachings, while still using the same power tool 10, thereby minimizing operation costs.

In a further preferred aspect of the present teachings, the two battery packs 30, 130 may have the same nominal output voltage, e.g., between 21-30 V, while having different nominal power outputs (wattages). This feature provides the advantages that the same charger or charging system may be used to charge both battery packs 30, 130 and the tool 10 will generally operate at the same speed, e.g., rotational speed, with both battery packs 30, 130. However, because the higher-power battery pack 130 is capable of outputting a higher current value, the tool 10 can be operated at higher output torques using the higher-power battery pack 130.

Such a kit or system provides a distinct advantage over the known system disclosed in US 2003/0203669 A1, which requires each different-sized battery pack to output the same nominal current, because power tool operations may be undesirably slow using the lower power battery pack due to the resulting slower rotational speed of the tool. Generally speaking, the voltage supplied to the electric motor determines its rotational speed, whereas the current supplied to the electric motor determines its torque. In the alternative, such a known design would require an additional variable transmission to be incorporated into the power tool in order to provide the same rotational speed, regardless of the battery voltage, thereby undesirably increasing the weight of the tool.

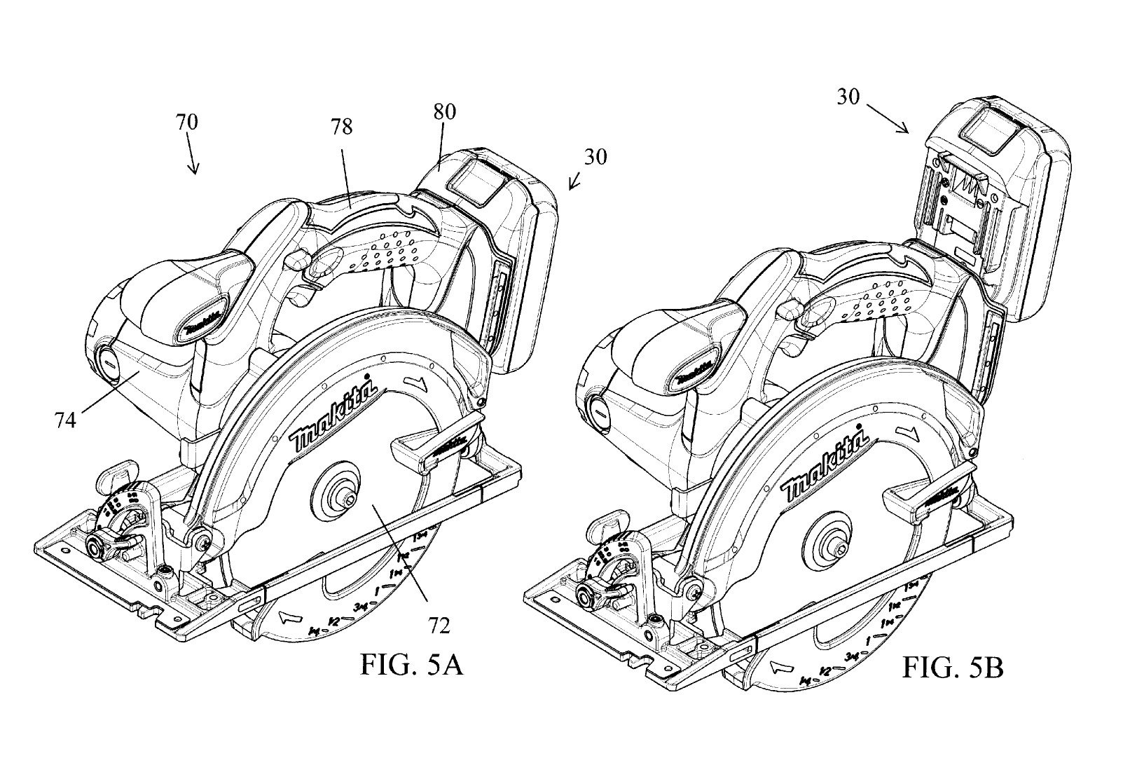

The present teachings are not limited to impact drivers 10 and may be advantageously utilized in a wide variety of hand-held, cordless battery-powered tools. For example, FIGS. 5A and 5B show a hand-held, cordless (battery-powered) circular saw 70 with the above-described light-weight battery pack 30 in an attached and detached state, respectively. The circular saw 70 generally comprises a circular saw blade 72, a gear transmission and motor housing 74, a trigger or switch 76 for manually activating an electric motor (not shown) disposed within the housing 74, a hand grip 78 and a battery holder 80. The electronic motor drives the circular saw 70, e.g. via a reduction gear transmission (not shown).

Although not shown, the circular saw 70 is also designed to utilize the higher-power battery pack 130 for heavy-duty cutting operations.

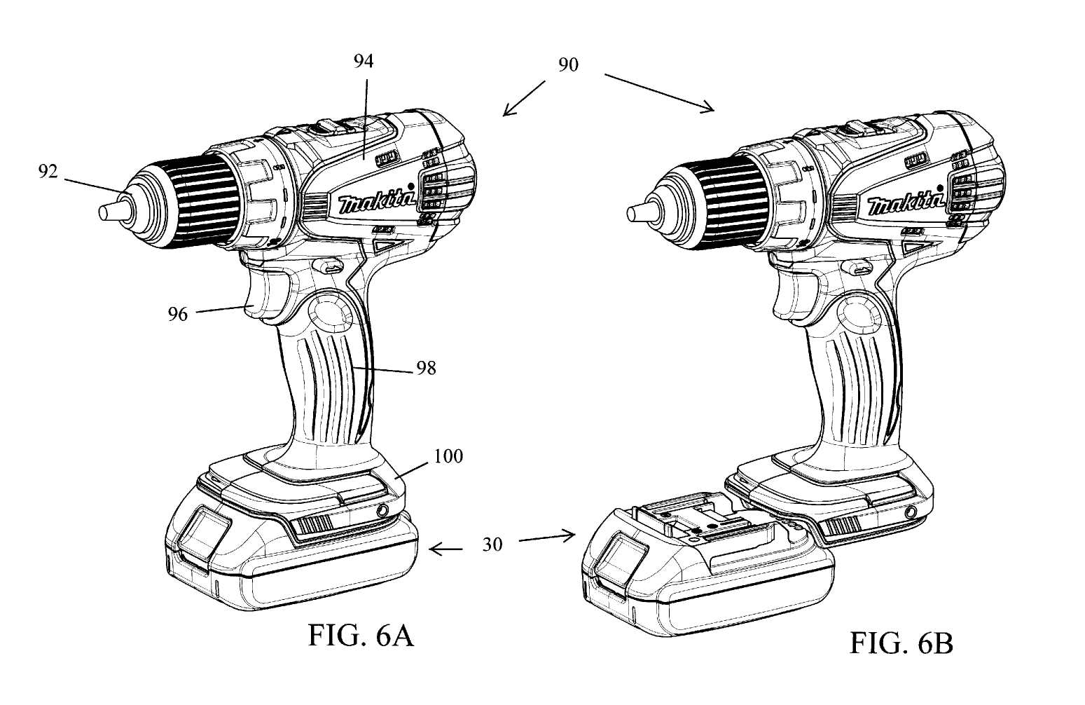

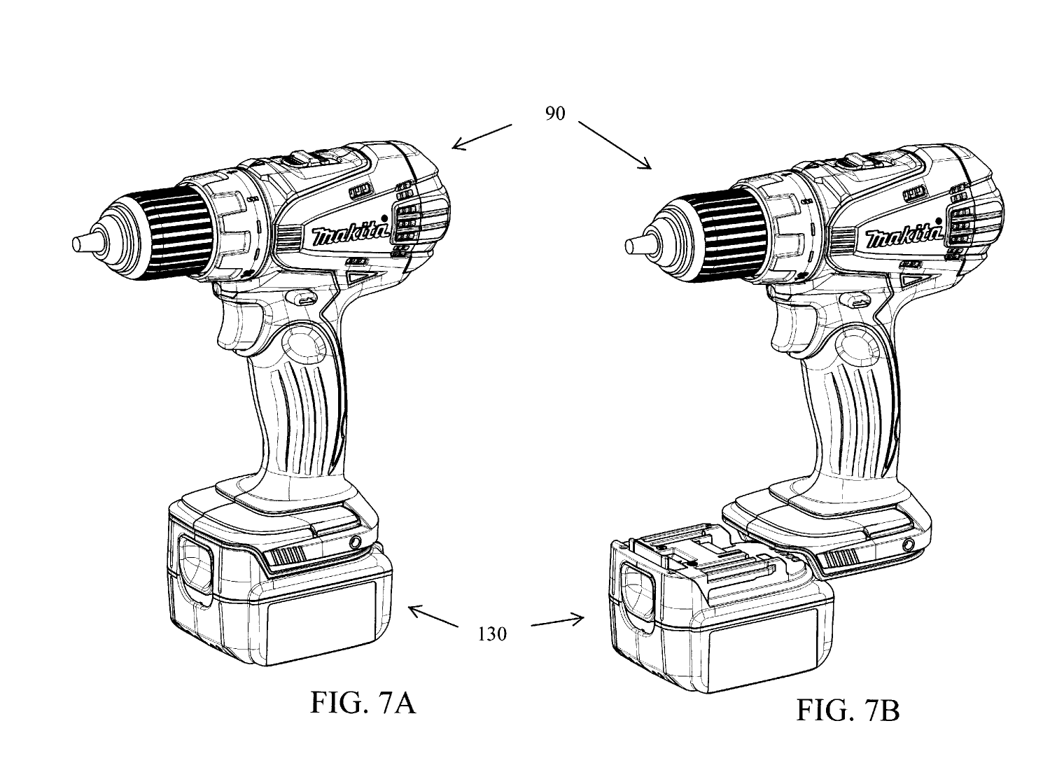

Similarly, FIGS. 6 and 7 show a hand-held, cordless (battery-powered) driver drill or screwdriver 90 that is capable of utilizing both of the above-described battery packs 30, 130. More specifically, FIGS. 6A and 6B show the battery-powered driver drill 90 with the above-described light-weight battery pack 30 in an attached and detached state, respectively. Furthermore, FIGS. 7A and 7B show the battery-powered driver drill 90 with the above-described higher power battery pack 130 in an attached and detached state, respectively.

Referring to FIG. 6A, the driver drill 90 generally comprises a tool chuck 92 configured or adapted to retain a rotatable tool, such as a driver bit or drill bit (not shown), a gear transmission and motor housing 94, a trigger or switch 96 for manually activating an electric motor (not shown) disposed within the housing 94, a hand grip 98 and a battery holder 100. The electronic motor drives the rotatable tool, e.g. via a reduction gear transmission (not shown).

Thus, as the preceding description demonstrates, the present teachings are generally applicable to any type of hand-held, cordless, battery-powered tool that would benefit from the above-described advantages. Power tools according to certain aspects of the present teachings are preferably configured, adapted and/or enabled to safely operate using a battery pack (e.g., battery pack 130) that has a nominal power output of at least 600 Watts. However, such power tools are also capable of operating at lower output power ranges using the light-weight battery packs 30 according to the present teachings.

For example, in certain aspects of the present teachings, providing a light-weight battery pack and a higher-power battery pack for a power tool may provide one or more of the following advantages.

An impact driver attached to a higher-power battery pack can drive a large screw at an appropriate speed because the higher-power battery pack is capable of supplying a relatively large current due to its lower impedance. On the other hand, when the impact driver is attached to a light-weight battery pack according to the present teachings, it can still drive a small screw at almost the same speed because the light-weight battery pack can supply approximately the same voltage as the higher-power battery pack.

Similarly, a driver drill attached to a higher-power pack can drill relatively large holes, because the higher-power battery pack can output a larger current, but again can also adequately drill smaller holes using the light-weight battery pack supplying the same (or approximately the same) nominal output voltage.

Moreover, a circular-saw attached to a higher-power battery pack can cut a thicker piece of wood, because the higher-power battery pack is capable of outputting a larger current. But, the light-weight battery pack will still be suitable for thinner pieces of wood.

The preceding are merely examples and the actual tool performance will depend on the properties of the battery pack and the power tool that are actually used.

According to an optional aspect of the present teachings, the present power tools 10, 70, 90 may further benefit by incorporating a current limiting circuit or discharge protection circuit that detects current flow across the motor of the power tool 10, 70, 90 and/or the battery cells 50 and disconnects or attenuates the current flow in case a current value above a threshold value is detected, such as, e.g., higher than 30 amps. Such a current limiting circuit would be advantageous in power tools and/or battery packs that are designed to operate below the current threshold level in order to protect motors, gear transmissions, electronics and/or battery packs that are not designed to safely operate at higher current values. Such a current limiting circuit would provide the advantage that a variety of battery packs having different nominal wattages, but the same nominal output voltage, may be utilized without fear of damaging the internal components of the power tool and/or battery pack due to excessive currents being generated.

Power tool systems according to the present teachings may be further designed to provide an additional optional advantage. Specifically, when the light-weight battery pack 30 is utilized with a T-shaped or L-shaped tool, e.g., the impact driver 10 or driver drill 90, the center of gravity of the tool may preferably lie within the upper half of the tool. For example, the center of gravity may preferably lie within the vertical height of the trigger 16, 96, i.e. in the direction that generally follows the handgrip 18, 98 and intersects the housing 14, 94 and the battery holder 20, 100. In this case, the power tool 10, 90 becomes easier to handle or manipulate, as it provides an optimal weight balance for most power tool operations.

Although lithium-based battery cells are presently preferred, in particular lithium ion battery cells, the present teachings are not particularly limited in this regard and battery packs may be constructed using any other suitable battery chemistry, such as, e.g., lithium metal oxide, lithium polymer, lithium metal phosphate and lithium sulfer or lithium sulfide or lithium sulphate.

Further exemplary embodiments of the present teachings include, but are not limited to:

1. A battery pack configured or adapted to be attached to, and drive, a hand-held power tool, the battery pack comprising:

a plurality of series-connected battery cells configured or adapted to have a nominal power output of at least 300 Watts, more preferably at least 330 Watts, even more preferably more than 350 Watts,

wherein the battery pack weighs less than 300 grams, more preferably less than 275 grams, more preferably less than 250 grams, more preferably less than 235 grams, even more preferably less than 220 grams.

2. The battery pack according to embodiment 1 further having a nominal power output to weight ratio of at least 1000 Watts/kilogram, preferably at least 1100 Watts/kilogram, more preferably at least 1170 Watts/kilogram, more preferably at least 1200 Watts/kilogram, more preferably at least 1230 Watts/kilogram, more preferably at least 1275 Watts/kilogram, more preferably at least 1320 Watts/kilogram, even more preferably at least 1350 Watts/kilogram, even more preferably at least 1400 Watts/kilogram, and even more preferably at least 1500 Watts/kilogram.

3. A battery pack configured or adapted to be attached to, and drive, a hand-held power tool, the battery pack comprising:

a plurality of series-connected battery cells configured or adapted to have a nominal power output of at least 300 Watts, more preferably at least 330 Watts, even more preferably more than 350 Watts,

wherein the battery pack has a nominal power output to weight ratio of at least 1000 Watts/kilogram, preferably at least 1100 Watts/kilogram, more preferably at least 1170 Watts/kilogram, more preferably at least 1200 Watts/kilogram, more preferably at least 1230 Watts/kilogram, more preferably at least 1275 Watts/kilogram, more preferably at least 1320 Watts/kilogram, even more preferably at least 1350 Watts/kilogram, even more preferably at least 1400 Watts/kilogram, and even more preferably at least 1500 Watts/kilogram.

4. The battery pack according to embodiment 3, further having a weight less than 300 grams, preferably less than 275 grams, more preferably less than 250 grams, more preferably less than 235 grams, even more preferably less than 220 grams.

5. The battery pack according to any preceding embodiment further having a nominal output voltage greater than 20 volts, e.g., between about 21 to 30 volts.

6. The battery pack according to any preceding embodiment, wherein the battery pack comprises less than eight lithium-based battery cells, e.g., six to eight battery cells, e.g., lithium-ion battery cells.

7. The battery pack according to any preceding embodiment, wherein the battery cells each have a ratio of surface area to volume that is greater than or equal to about 0.30, more preferably greater than or equal to 0.33.

8. The battery pack according to any preceding embodiment, wherein the battery cells are each cylindrical shaped and each have a diameter equal to or less than about 14 mm.

9. The battery pack according to any preceding embodiment, wherein the battery cells each have a length equal to or less than about 55 mm, more preferably equal to or less than 50 mm.

10. The battery pack according to any preceding embodiment, further having a nominal output current equal to or less than about 18 amps, more preferably equal to or less than 15 amps.

11. The battery pack according to any preceding embodiment, further having a nominal capacity of equal to or less than about 1 amp-hour, preferably equal to or less than about 0.9 amp-hour, more preferably equal to or less than about 0.8 amp-hour, even more preferably between about 0.5-0.7 amp-hour.

12. The battery pack according to any preceding embodiment, wherein the battery pack comprises seven lithium ion battery cells connected in series and having a nominal output voltage of about 25 volts.

13. The battery pack according to any preceding embodiment, further comprising one or more of battery terminals configured or adapted to be electrically connected to battery terminals of the hand-held power tool, a controller communication port, engaging means, such as slide rails, for engaging the battery pack with a battery holder of the hand-held power tool and/or locking means, such as a user-operable latch, for detachably locking the battery pack to the hand-held power tool.

14. The battery pack according to any preceding embodiment, further comprising a current limit circuit configured to limit the amount of current flowing across the battery cells, e.g., having a current threshold of 18 amps or less, more preferably 15 amps or less.

15. A power tool system or kit comprising:

a hand-held, battery-powered tool configured to operate with a battery pack having a nominal power output of 600 Watts or more, more preferably 700 Watts or more, even more preferably 800 Watts or more and

the battery pack according to any preceding embodiment.

16. The power tool system or kit according to embodiment 15, wherein the hand-held, battery-powered tool comprises a tool housing, an electric motor and transmission disposed within the tool housing and/or a trigger configured to actuate the electric motor to drive the transmission.

17. The power tool system or kit according to embodiment 15 or 16, wherein:

the hand-held, battery-powered tool at least substantially has an L-shape or a T-shape overall and includes a trigger that is disposed in a vertical direction between a motor housing and a battery holder, and

when the battery pack is attached to the battery holder, the power tool system has an overall center of gravity that lies within the height of the trigger in the vertical direction.

18. The power tool system or kit according to embodiment 15, 16 or 17 further comprising:

a second battery pack having a nominal power output of at least 600 Watts, more preferably at least 700 Watts, even more preferably at least 800 Watts, and at least substantially the same output voltage as the battery pack of embodiments 1-14,

wherein the hand-held, battery-powered tool is configured to attach to, and be driven by, both battery packs.

19. The power tool system or kit according to any one of embodiments 15-18, wherein the hand-held, battery-powered tool further comprises a current limit circuit configured to limit the amount of current flowing to the electronic motor of the hand-held, battery-powered tool and/or to the battery pack.

20. The power tool system or kit according to embodiment 19, wherein the current limit circuit has an upper current threshold of 30 amps.

21. The power tool system or kit according to any one of embodiments 18-20, further comprising a charger configured or adapted to charge the battery pack of embodiments 1-14 and the second battery pack of embodiment 18, both of which have the same or approximately the same nominal output voltage, e.g., about 21-30V.

22. The power tool system or kit according to any one of embodiments 15-21, wherein the hand-held, battery-powered tool is an impact driver, a circular saw or a driver drill.

23. The power tool system or kit according to any one of embodiments 15-22, wherein the hand-held, battery-powered tool weighs less than 2 kilograms, more preferably less than 1.5 kilograms, more preferably less than 1.3 kilograms, even more preferably less than 1.0 kilogram.

24. The battery pack or power tool system or kit according to any preceding embodiment, wherein the battery cells 50 preferably have an internal resistance (Rbatt) equal to or less than 50 milli-ohms, more preferably equal to or less than 45 milli-ohms, even more preferably equal to or less than 40 milli-ohms.

### REFERENCE SIGN LIST

10 impact driver
12 tool chuck
14 housing
16 trigger
18 hand grip
20 battery holder
30 battery pack
32 outer casing
34 slide rails
36 latch
38 battery terminals
40 separator plate
41 battery terminal groove
42 input/output connection groove
50 battery cells
52 conductors
70 circular saw
72 circular saw blade
74 housing
76 trigger
78 hand grip
80 battery holder
90 driver drill
92 tool chuck
94 housing
96 trigger
98 hand grip
100 battery holder
130 battery pack
150 battery cells

1. A battery pack configured or adapted to be attached to, and drive, a hand-held power tool, the battery pack comprising:
a plurality of series-connected battery cells configured or adapted to have a nominal power output of at least 300 Watts,
wherein the battery pack weighs less than 275 grams.

2-28. (canceled)
